(19) United States
(12) Patent Application Publication
(10) Pub. No.: US 2006/0073241 A1
(43) Pub. Date: Apr. 6, 2006

(54) Alcoholic beverage container

(76) Inventor: David Vallentine, Perth (AU)

Correspondence Address: Galgano & Burke;Suite 35, 300 Rabro Drive, Hauppauge, NY, 11788, US

(21) Appl. No.: 10/351,874

(22) Filed: Jan. 24, 2003

(30) Foreign Application Priority Data
Jan. 25, 2002 (NZ) 516801

(51) Int. Cl. A23B 7/148

(52) U.S. Cl. 426/106

(57) ABSTRACT

A sealed plastic container for holding an alcoholic beverage such as wine includes a receptacle for containing the alcoholic beverage therein which includes a peripheral flange about the mouth of the receptacle, a biocompatible inner surface and a wall having a low gas transmissibility and a sealing membrane detachably fixed to the flange and including a biocompatible inner surface. The sealing membrane is fitted to the peripheral flange such that it can undergo displacement in the event of expansion of the contents of the container. The container including a biocompatible gas other than oxygen and the membrane seals the alcoholic beverage from contact with air.

### BACKGROUND

The present invention relates to beverage containers particularly sealed containers but more particularly relates to a sealed ready to use alcoholic beverage container and a method of production of a wine filled container and packaging thereof. More particularly the invention relates to an alcoholic beverage container having an improved headspace which accommodates variations in environmental conditions.

### PRIOR ART

Containers for liquid beverages have in the past been manufactured in a wide variety of forms whereby greater use has been made of soft packaging formed from plastics or fibre materials as an alternative to use of glass. One such package is manufactured from cardboard including a layer of plastics material and a metallic layer and comprises a box like receptacle with a small opening through which a straw passes to gain access to the beverage. The opening has a frangible sealing membrane across it which keeps the contents airtight and which must be invaded to gain access to the inside of the container.

This class of containers is generally used for soft drinks and although they have previously been used for holding alcoholic beverages, as consumers of the latter are discerning in their acceptance of containers from which they partake of alcohol and particularly wines such containers have not gained market acceptance. There is consumer resistance to alcoholic beverages dispensed from such containers. Another known sealed airtight container for liquid beverages comprises a receptacle, formed from a plastics material and having a heat sealed membrane or cover which ensures the package is air tight. The membrane generally comprises a sheet of aluminium foil which engages a peripheral flange formed on the receptacle. This class of containers has previously been used for non-alcoholic liquid beverages such as soft drinks, particularly juices and long life milk. The aluminium foil used in these containers is flat and allows a small headspace between the underside of the container and the upper surface of the fluid contained therein. Access to the contents is gained by simply peeling off the aluminium foil away from the flange to which it is sealed. Up until the invention disclosed in Australian patent No. 706348, it had not hitherto previously been known to package alcoholic beverages in such containers. To do so required special techniques in the production of the product to ensure that the alcoholic beverage is not oxidized or otherwise degraded. Furthermore, it was necessary to select the appropriate plastics material for the container and to ensure that a headspace gas was provided in the container which gas helps prolong the shelf life of the contents at least for up to six months.

Alcoholic beverages have in the past been packaged in bottles, casks, satchels and cans. Wine products have to date been served in large and small bottles or in collapsible casks. Where serving elegance is a consideration, bottles or glasses are the preferred containers with the former providing multiple serves and the latter providing a single serve. There are some circumstances where alcoholic beverages are in single serve demand such as in entertainment venues, bars or restaurants or in flight. In these circumstances, it can be inconvenient and time consuming for an attendant to fill consumers' glasses. It is very common for self contained sealed containers of soft drinks and juices to be served quickly in these situations due to the availability of single serve sealed packages for these products. However, this was rot the case with alcoholic beverages particularly wine and particularly where a single serve only is required, as these beverages were previously not prior to AU706348 packaged in plastics in a self contained sealed convenient ready to use font.

Packaging alcohol in plastic containers has traditionally been considered undesirable by suppliers of alcohol products. Consumable liquids such as soft drinks previously and presently packaged in plastics containers have a short shelf life and must be used soon after packaging. As plastics are known to allow gas transmissibility therethrough, the contents of a plastics container are prone to oxidation soon after packaging, i.e. within days or over a few weeks. Despite the inherent difficulties in the use of plastics for liquid beverages, the invention in. AU706348 provided one solution which increased the shelf life of an alcoholic beverage stored in a plastics container to at least six months without compromise to the integrity of the alcoholic contents. In order to successfully package alcohol in plastics containers for the consumer market it was necessary to address the problem of gas transmissibility through the plastics material and to develop a production process whereby unwanted gases in and around die alcoholic beverage could be purged before sealing the plastics container.

A number patents teach attempts to provide single serve wine containers but none of those provide a practical, workable solution to the known problems which arise from inefficient headspace design. Some examples of the known single serve wine containers are set out below

DE 3814937

Whilst this disclosure teaches use of a single glass of wine there is no reference to a headspace configuration of which is essential for accommodation of phenomena such as expansion of wine. The citation does not indicate whether the plastics foil disclosed is connected to the glass nor its relationship with the wine and the nature of any, headspace. Furthermore as a glass container is used, merely introducing a foil over the top of the glass does not provide the reader with an understanding of how the problems of O₂ transmission might be overcome and how the headspace will be created to accommodate wine expansion.

U.S. Pat. No. 5,246,106

This patent does not teach a single serve wine container which overcomes the problems inherent in introducing wine into plastics containers. In this device, the headspace is arbitrary and would provide facility and space for Oxygen to eater. The sealing membrane in the patent is not concave but flush with the upper reaches of the container indicating an increased susceptibility to Oxygen contamination due to the larger headspace.

U.S. Pat. No. 4,082,854

The disclosure teaches improved gas permeation resistance but does not teach the application of this to single serve wine containers.

U.S. Pat. No. 4,738,857 to Daher teaches an alcoholic beverage container having a substantial shelf life of around 1 year and also discloses use of plastics in a container for holding the alcoholic beverage. The patent also recognizes materials having stability to alcohol and the problems of oxygen contamination. The patent further teaches the use of lidding which can be a metallic foil provided that the internal layer which may be in contact with the alcoholic beverage is inert to the alcoholic beverage. What this patent does not teach is a specially configured headspace which satisfies the dual requirements of minimizing the opportunity for Oxygen degradation and providing a flexible seal and enough space for expansion of the beverage therein.

No thin walled plastics containers are totally impermeable to gases but it was found that permeability could be dramatically reduced if an appropriate selection of plastics material was made. This, in combination with the method of production of the finished container results in an alcoholic beverage free of problems such as oxidation for a period of up to and conceivably beyond 6 months. A suitable plastics receptacle for holding alcohol may comprise a single layer or multiple layers of plastics. Preferably, the inside surface of the receptacle is biocompatible as is the inner surface of the membrane which seals the receptacle. Although the invention disclosed in 706348 was breakthrough in wine packaging technology it was recognized that there were improvements to be made to the manner in which single serve wine containers were constructed and more particularly to the headspace configuration.

### INVENTION

The present invention provides an alternative plastics container for use in the service of alcoholic beverages including an improved sealing membrane configuration resulting in a longer shelf life than the known single serve wine containers.

According to the present invention, there is provided with a single serve container a flexible seal to accommodate expansion of an alcoholic beverage container therein and which is preferably recessed beneath the point of sealing between the membrane seal and the container with the result that the ullage volume is so reduced that the gas volume of the headspace is so small that the concentration of the residual oxygen present is insignificant. As a result, the seal will flex where the wine expands with temperature.

In one broad form of the apparatus aspect, the present invention comprises; a sealed plastics container for holding an alcoholic beverage such as wine; the container comprising, a receptacle for containing the alcoholic beverage therein and which includes a peripheral flange about the mouth of the receptacle, a biocompatible inner surface and a wall having low gas transmissibility; a sealing membrane detachably fixed to said flange and including a biocompatible inner surface, wherein the sealing membrane is fitted to said peripheral flange such that it can undergo displacement in the event of expansion of the contents of the container the container including a biocompatible gas other than oxygen, wherein the membrane seats the alcoholic beverage from contact with air.

Preferably there is little or no headspace between the underside of the membrane and the surface of the contents of the container.

Preferably the sealing membrane is flexible and its diameter is greater than the outside diameter of the flange of the container to which it is attached.

According to one embodiment the flexible membrane is at least partially recessed beneath the connection point of the membrane and flange.

According to a preferred embodiment, the invention comprises a self contained sealed container for containing a single serve of wine, wherein the container comprises; a plastics receptacle having the appearance of a carafe, drinking glass or the like and a membrane sealing the contents therein. Preferably, no headspace is formed between the beverage and the biocompatible inner surface of the membrane and the biocompatible gas many be gases such as but not limited to Nitrogen or Carbon Dioxide. According to the preferred embodiment, the receptacle is produced in a mould and formed from a transparent or opaque plastics material such as but not limited to polypropylene. Other materials which could be used are polystyrene and polyethylene. The receptacle has properties which minimize oxygen and carbon dioxide transmissibility and render the receptacle alcohol tolerant in most environmental conditions. Alternatively, the receptacle may be formed of multiple layers with at least the inner layer comprising a biocompatible plastics material such, as virgin (i.e. not recycled) polypropylene and has the appearance of a glass or the like suitable for drinking wine in single serves. Alternatively, the inner layer may be polyethylene. Alternatively, the receptacle is formed from a plurality of layers of material having low gas transmissibility from the external environment and low leeching capability from the internal environment to the outside of the receptacle such that gas entrained in the wine or other alcoholic beverage in the container will be prevented from escaping.

According to one broad form of the method aspect, the present invention comprises, a method of production of a sealed container for holding an alcoholic beverage as hereinbefore described, comprising the steps of: (a) taking a plastics receptacle having a biocompatible inner surface and a 15 wall having a low gas transmissibility property suitable for holding the alcoholic beverage therein and with an open mouth having a peripheral flange thereabout, (b) taking a membrane having at least one layer with or formed from a biologically, electrically and/or chemically inert or non reactive substance 20 or material, (c) filling the receptacle with an alcoholic beverage such as wine, (d) introducing gaseous nitrogen or other suitable food grade gas into the receptacle under positive pressure and in a controlled environment to displace residual oxygen remaining in the receptacle, (e) placing the membrane over the open mouth so that at least a portion of the membrane remains flexible enough to allow displacement thereof responsive to expansion of the contents of the container and so that a n on reactive material layer is on the inside and so that it engages with the peripheral flange) (f) beating the membrane or heating the receptacle so that an adhesive on the membrane melts onto the flange causing the membrane to air-tight seal the mouth of the receptacle.

According to a preferred embodiment, the method further comprises before the filling step takes place, purging the receptacle of oxygen. According to another forming of the method aspect the present invention comprises; a method for producing a sealed plastics container for an alcoholic beverage such as wine comprising the steps of; a) taking a plastics receptacle from a plastics material, b) introducing an alcoholic beverage into the receptacle, c) displacing residual oxygen from the receptacle by introducing gaseous Carbon Dioxide, Nitrogen or a mixture of both in predetermined proportions or other suitable food grade gas into the receptacle, d) applying a membrane to the open mouth of the receptacle so that the membrane adheres by heat sealing to a peripheral flange formed around the open, mouth of the receptacle to thereby provide an airtight seal; characterized in that part of the membrane is recessed below the flange and engages an upper surface of the liquid beverage in the container such that there is little or no headspace.

According to one embodiment, the container comprises a transparent or opaque plastics receptacle which has high resistance to transmission of gases such as oxygen and which has a membrane of aluminium placed across the open mouth to create a seal. The adhesive is applied to the membrane either as a coating formed from the biologically, electrically and/or chemically inert or non reactive substance or in addition to that substance as an additional layer about the periphery of the membrane. The sealing membrane is attached by heat sealing.

This absence of any headspace ensures that the wine is compatible with the environment within the receptacle once the production method is complete and when the wine is packaged.

According to an alternative embodiment, of the method aspect of the invention, the container may be completed by the additional steps of adding a plastic lid over the membrane for reuse of the container once the membrane is removed. Also, the metallic membrane may be preheated prior to fixing to the flange of the container with the pre-heating melting a glue or glue like substance either on the flange or on the inner surface of the sealing membrane.

### DETAILED DESCRIPTION

The present invention will now be described in more detail according to a preferred but non limiting embodiment and with reference to the accompanying illustrations wherein;

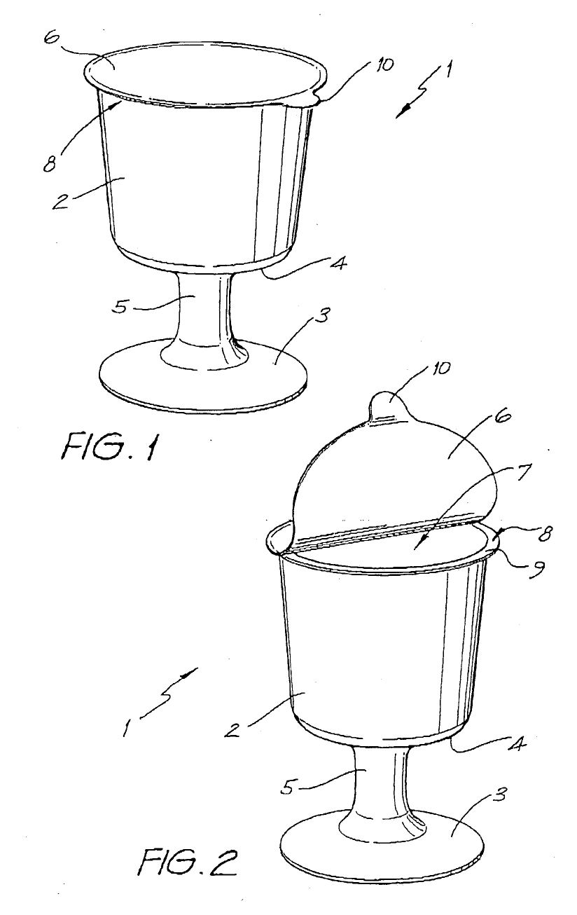

FIG. 1: shows an elevation of a known container for holding an alcoholic beverage;

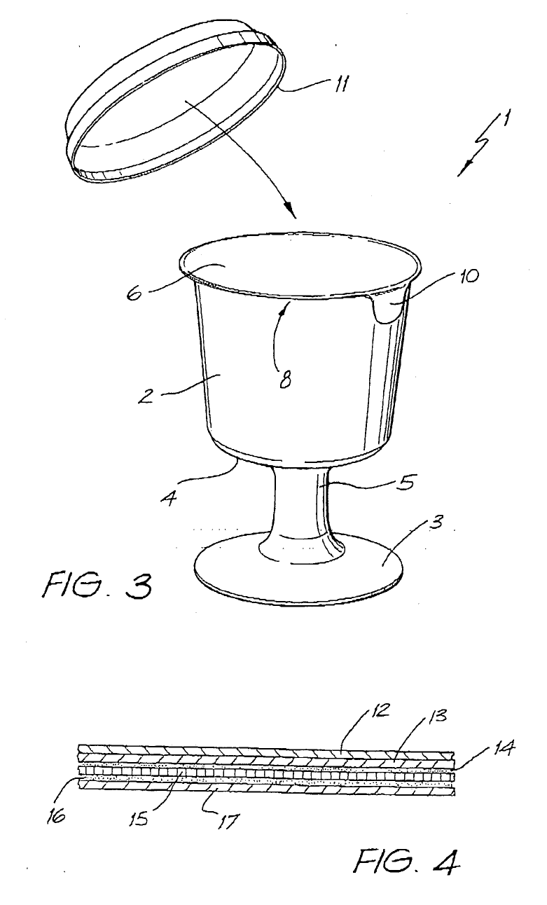

FIG. 2: shows the container of FIG. 1 with the sealing membrane peeled away from the peripheral flange around the open mouth of the receptacle;

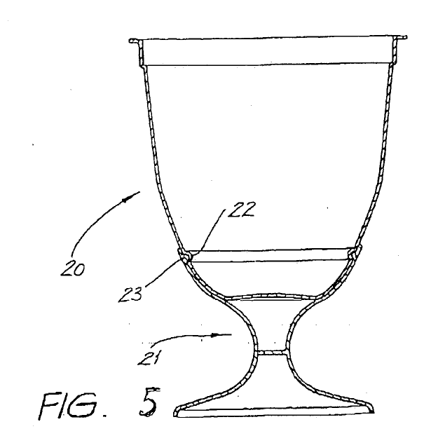

FIG. 3: shows the container of FIG. 1 with a sealing cover;

FIG. 4: shows a schematic view of a multi layer arrangement for the receptacle;

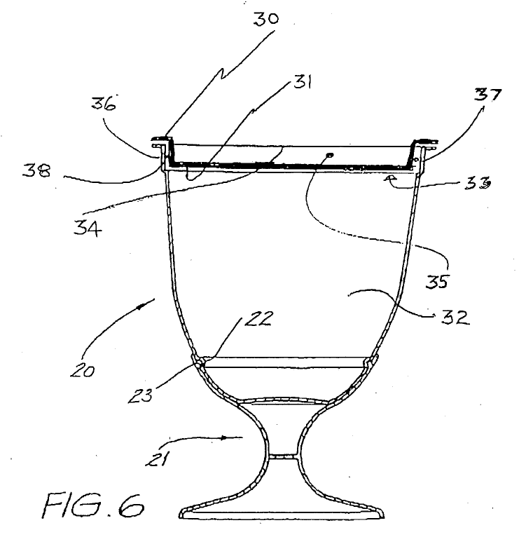

FIG. 5 shows a cross sectional elevation view of the single serve container of FIG. 1; and with recessed sealing membrane according to a preferred embodiment of the invention.

FIG. 6: shows a cross sectional elevation view of a single serve container with recessed sealing membrane according to a preferred embodiment of the invention.

Referring to FIGS. 1 and 2 there is shows a known container I for alcoholic beverages. Container I comprises a plastics receptacle 2 which )Day assume the general shape of a wine glass for holding an alcoholic beverage. The receptacle may have the appearance of a conventional glass receptacle such as a tumbler or other glass shaped receptacles used for serving alcoholic beverages and also including carafes and the like To enhance the appearance of receptacle 2 as a suitable container from which wine may be directly consumed, the receptacle is adapted 5 with a base 3 which is connected to the underside 4 of receptacle 2 via stem 5.

Receptacle 2 is sealed prior to use and in order to facilitate said sealing a membrane 6 covers the open mouth 7 of receptacle 2. In order to enable effective air tight sealing, a peripheral flange 8 (see FIG. 2) is moulded into the receptacle. The upper surface 9 of flange 8 provides a surface which receives and enables bonding thereto of the membrane 6. Membrane 6 also has a second layer comprising a biocompatible coating which isolates the contents of the receptacle 2 from the primary membrane material. The membrane material is thin aluminium sheet coated on the inside face with a layer of chemically, electrically and biologically inert material and preferably a selected polymer such as polypropylene. FIG. 3 shows the container of FIGS. 1 and 2 with optional lid 11 exploded away. FIG. 4 shows one possible embodiment of the constituents of a multi layer plastics walled container. As shown schematically in. FIG. 4 receptacle 2 may be of multi layer construction 20 formed from an inner layer 12 of virgin polypropylene. However, the receptacle may be formed from a single layer of plastics material such as but not limited to modified nylon. Layer 13 comprises scrap polypropylene as this will not come in contact with the alcoholic beverage.

Scrap polypropylene layer 13 is in apposition with adhesive layer 14 which in turn is in apposition with EVOH core layer 15. An adhesive layer 16 overlies layer 15 and is itself overlain by layer 17 which comprises scrap polypropylene.

The layered receptacle 2 must be impermeable to oxygen absorption and to carbon dioxide leeching to ensure that the alcoholic beverage does not undergo oxidation or other form of degradation. This is achieved by careful selection of the plastics material 30 used in the multi layered or single layer receptacle wall. Layer 17 of receptacle 2 may be mixed with a preselected colourant.

In use, seating membrane 6 is simply peeled away from flange 8 to gain access to the contents of the receptacle as shown in FIG. 2.

FIG. 5 shows receptacle 20 seated in stem 21.

According to a preferred embodiment of the method aspect, container 1 is produced according to the following regime. The first step is to produce the receptacle 2 and this is effected by moulding polypropylene (or other suitable material through which oxygen cannot penetrate) to ensure that the integrity of the sealing of the contents is maintained and thus to ensure that oxidisation of the liquid beverage does not take place.

Preferably, receptacle 2 is moulded into the shape of a glass. To satisfy consumer preference for container of alcoholic beverages. Each receptacle 2 is set in position on a production line where it is filled via dispensers with the selected alcoholic beverage which may be white or red wine, beer or any other alcoholic beverage. On the inner surface of the aluminium membrane is a biocompatible lacquer layer or layer formed from a material which performs the roles of isolating the contents of the receptacle 2 from the aluminium, and providing a sealing material which melts under the sealing process.

During or moments after the preheating any residual oxygen is evacuated from the receptacle by injection of gaseous nitrogen or other suitable food grade gas into the contents. The membrane is presented to the peripheral flange 8 immediately the evacuation has been completed thereby effecting sealing of the contents. To consume the contents, the user simply pulls tab 10 of membrane 6 away from flange 8 as shown in FIG. 2. FIG. 3 shows a cover 11 detached from the container of FIG. 1. Receptacle 2 can be reseated where necessary by the removable cover 11 which engages the peripheral flange 8. Cover 1l can also be used to cover and protect membrane 6 prior to use.

The selection of an appropriate combination of plastics when a multi-layered receptacle is required and the selection of a suitable plastic for a single layer receptacle is made with reference to the behaviour and a number of properties of the selected plastics materials. These include clarity flexural modulus, impact strength density oxygen transmissibility and carbon dioxide transmissibility.

To fully appreciate the invention, necessitates an appreciation of the chemistry involved in wine manufacture and packaging and in particular, the importance of eliminating contact between oxygen aid the wine to avoid degradation and to maximize shelf life. This is perhaps most important in wine over any other liquid beverage due to the sensitivity of wine chemistry to air and particularly oxygen. Traditionally wine has been bottled although there have been other forms of packaging such as the wine cask which involves use of a collapsible bladder. Both forms of packaging accommodate multiple serve quantities. In the case of glass packaging oxygen may only be entrained through the cork which is unlikely allowing a long shelf life.

Thus, in adopting plastics packaging for wine it is most important to use biocompatible materials and to ensure effective seating against oxygen entrainment or entrapment in the container. This can occur through the walls of the container where an inappropriate material is used but is most likely to occur through the seal between the closure membrane and the flange at the upper reaches of the container where the seal engages the receptacle.

However the present invention involves minimizing or eliminating the space between the biocompatible inner layer of the seating membrane and the upper surface of the wine. Much turns on the nature of the headspace and is preferably kept to a minimum to the extent that there may be contact between the upper surface of the wine and the underside surface of the sealing membrane. This may result in the membrane being angled at its edges above the fill line and below the sealing zone rather than flush with) the surface of the liquid contents This is achieved by recessing the sealing membrane such that it is generally concave inwards. The seal according to one embodiment is concave inwards to minimize the headspace thereby manifesting the advantage of having a negligible or no headspace which minimizes the prospect of Oxygen contamination of the wine. The headspace could perhaps be considered a compromise between minimization of headspace but ensuring just enough space to accommodate wine expansion.

In the present invention, the seal is flexible to accommodate expansion and is also recessed with the result that the ullage voluble is so reduced that the gas volume of the headspace is so small that the concentration of the residual oxygen present is insignificant. As a result the seal will flex where the wine expands with temperature and this is not possible in the cited art or in bottled wine where any expansion is taken through compression of the cork.

FIG. 6 shows a preferred seal arrangement to demonstrate a preferred seal arrangement and configuration. FIG. 6 is in most respects similar to the container described in FIGS. 1-5 with corresponding parts numbered the same. FIG. 6 differs from the arrangements of FIGS. 1-5 in that membrane 30 is placed to that underside surface 31 opposes and is at least partially in contact with a beverage 32 when container 20 is filled to fill line 33. It can be seen that membrane 30 is recessed to minimize the space between the wine beverage and the biocompatible underside of the seal. A headspace will almost be completely eliminated between surfaces 31 and fill line 33. Line 34 shows the relative position of the membrane according to the prior art and it will be seen that in eliminating a headspace between line 34 and fill line 33 results in a corresponding recess 35. To enable the membrane 30 to conform to its configuration and to allow the membrane to displace in the event of an environmental change causing expansion of beverage 32, membrane is longer the the outside diameter of the container which it seals.

This results in the formation of walls 36 and 37 which enables membrane 30 to essentially sit on the surface of beverage 35. This also may have the effect of creating a small vertical but negligible headspace 38. Elimination of the headspace is achieved by overfilling the container with beverage past fill line 33.

It will be recognized by persons skilled in the art that numerous variations and modifications can be made to the invention as broadly described herein such as but not limited to changing the order of the method steps and/or altering the materials of construction of the container without departing from the overall spirit and scope of the invention.

1 A sealed plastics container for holding an alcoholic beverage such as wine; the container comprising,
a receptacle for containing the alcoholic beverage therein and which includes a peripheral flange about the mouth of the receptacle, a biocompatible inner surface and a wall having low gas transmissibility;
a sealing membrane detachably fixed to said flange and including a biocompatible inner surface, wherein the sealing membrane is fitted to said peripheral flange such that it can undergo displacement in the event of expansion of the contents of the container the container including a biocompatible gas other than oxygen, wherein the membrane seals the alcoholic beverage from contact with air.

2 A sealed container according to claim 1 wherein there is little or no headspace between the underside of the membrane and the surface of the contents of the container.

3 A sealed container according to claim 2 wherein the sealing membrane is flexible and its diameter is greater than the outside diameter of the flange of the container to which the membrane is attached.

4 A sealed container according to claim 3 wherein the flexible membrane is at least partially recessed beneath a connection point of the membrane and flange.

5 A sealed container according to claim 4 wherein said sealing membrane includes a biocompatible inner surface and is detachably fixed to said flange with sufficient flexibility so that at least a portion of said membrane engages a fill line of said beverage such that there is no headspace between the alcoholic beverage and the biocompatible inner surface of the sealing membrane; wherein., the membrane seals the alcoholic beverage from contact with air.

6 A container according to claim 5 wherein the sealing membrane may be peeled away, from the peripheral flange to expose the alcoholic beverage.

7. A container according to claim 2 wherein the sealing membrane comprises a composite of aluminium forming an outer layer and.a plastics material forming a biocompatible inner layer.

8 A container according to claim 7 wherein when the receptacle is formed from, multiple layers of plastics material comprising a first biocompatible inner layer comprising virgin polypropylene.

9 A container according to claim 8 wherein the multiple layers of plastics comprises in addition to an inner layer of virgin polypropylene a first layer of scrap polypropylene, an EVOH core layer and a second layer of scrap polypropylene.

10. A container according to claim 9 wherein when a single layer is used it comprises a food grade inert plastics material.

11. A method for packaging an alcoholic beverage in a container of the type comprising;
a scaled plastics container for holding an alcoholic beverage such as wine; the container comprising,
a receptacle for containing the alcoholic beverage therein and which includes; a biocompatible inner surface and a wall having a low gas transmissibility property, a peripheral flange about the mouth of the receptacle, a biocompatible inner surface and a wall having low gas transmissibility;
a sealing membrane detachably fixed to said flange and including a biocompatible inner surface, wherein the sealing membrane is fitted to said peripheral flange such that it can undergo displacement in the event of expansion of the contents of the container the container including a biocompatible gas other than oxygen, wherein the membrane seals the alcoholic beverage from contact with air; wherein there is little or no headspace between the underside of the membrane and the surface of the contents of the container a sealing membrane including a biocompatible inner surfaces detachably fixed to said flange so as to form a headspace between the alcoholic beverage and the biocompatible inner surface of the sealing membrane which contains a biocompatible gas other than oxygen;
wherein the membrane seals tile alcoholic beverage from contact with air; and wherein the receptacle wall is formed from multiple layers of plastics materials or a single layer of plastics material;
the method comprising the steps of;
(a) taking the plastics receptacle having a biocompatible inner surface and a wall having a low gas transmissibility property suitable for holding the alcoholic beverage therein and with an open mouth having a peripheral flange thereabout,
(b) taking a membrane having at least one layer with or formed from a biologically, electrically and/or chemically inert or non reactive substance or material,
(c) filling the receptacle with an alcoholic beverage such as wine,
(d) introducing gaseous nitrogen or other suitable food grade biocompatible gas into the receptacle under positive pressure and in a controlled environment to displace residual oxygen remaining in the receptacle,
(e) placing the membrane over the open mouth so that said non-reactive material layer is on the inside and so that it engages with the peripheral flange and a fill line of said beverage so that there is little or no headspace;
(f) heating the membrane or heating the receptacle so that an adhesive on said membrane melts onto the flange causing the membrane to air-tight seal the mouth of the receptacle.

12 A method according to claim 16 comprising the further step of applying a detachable lid to the receptacle such that a recess on the lid engages the peripheral flange irrespective of whether the membrane is on or off the receptacle.

13. A method according to claim 17 wherein the biocompatible gas may be Carbon Dioxide, Nitrogen or a combination of both in predetermined proportions.

14. A method according to claim. 18 wherein the receptacle comprises layered plastics wherein the inner layer is virgin polypropylene and is biocompatible with a low oxygen transmissibility coefficient.

15 A sealed plastics container for holding an alcoholic beverage according to claim 1 wherein said membrane when applied to said container is recessed partially below said flange wherein said recessed part approximates a beverage fill line and wherein upon expansion of said beverage, said recessed part of said membrane is capable of deformation away from said fill line to a location at least flush with said peripheral flange.

16 A sealed plastics container according to claim 15 wherein the membrane is flexible and is located on the receptacle so as to eliminate headspace but allow for expansion of the alcoholic beverage in the event of an environmental change such as temperature elevation.
